(19) United States
(12) Patent Application Publication
(10) Pub. No.: US 2011/0061509 A1
(43) Pub. Date: Mar. 17, 2011

(54) Wood working machine

(75) Inventor: Thomas Scherl, Ulm (DE)

(73) Assignee: Scheppach Fabrikation von Holzbearbeitungsmaschinen GmbH, Ichenhausen (DE)

(21) Appl. No.: 12/923,230

(22) Filed: Sep. 10, 2010

(30) Foreign Application Priority Data
Sep. 12, 2009 (EP) 09 400 045.2

(51) Int. Cl. B23D 47/02; B27G 19/02; B23D 45/06

(52) U.S. Cl. 83/474; 83/477.2

(57) ABSTRACT

The invention relates to a table widening module for a machine tool (1), especially a panel sizing circular saw (1), with an extension element (5) comprising for widening of a machine table (3) an extension plate (8), which can be positioned adjacent to the machine table (3) in an extension direction (A) and is especially flush on top with the machine table (3), as well as a number of extension arms (7a, 7b) fastenable to the extension plate (8) and received in a guided manner in the extension direction (A) in an allocated number of guide rails (6a, 6b; 206a, 6b; 306a, 6b) fastened on the table so that the distance of the extension plate (8) to the machine table (3) is variable.

The invention is characterised by the fact that the extension element (5) for retrofit from the machine table (3) side located in the extension direction (A) to the opposite machine table (3) side is formed with a number of extension arms (7a, 7b) fixed to the extension plate (8), in order to widen the machine table (3) optionally on one side or on the other side, and the number of guide rails (6a, 6b; 206a, 6b; 306a, 6b) for receiving and removing the allocated extension arms (7a, 7b) is formed in a condition fitted on the table with an extension plate (8) positioned optionally on the machine table (3) side located in the extension direction (A) or an extension plate (8) positioned on the machine table (3) side located in the opposite direction.

Moreover the invention relates to a wood working machine.

The invention relates to a wood working machine according to the preamble of claim 1.

In the case of machine tools, in particular wood working machines such as for example circular saws or the like, often very wide workpieces such as for example wide chip boards must be lead past a tool passing through a machine table such as for example a saw blade or disk (in the case of a circular saw). If the workpiece is so wide that its centre of gravity is located adjacent to the machine table, there is a risk that the workpiece during treatment tilts outwardly. To avoid this, a user must press the workpiece with all his might onto the surface of the machine table with a high risk of injury being involved because the user and/or operator during tilting of the workpiece and/or a pushing movement against it might easily get his fingers caught in the tool.

Therefore, on machine tools and in particular on wood working machines of the generic type, a table widening are often attached to the machine table comprising an extension plate located adjacent to the machine table, with the extension plate being positioned at a variable distance to the machine table via a number of extension arms attached to the extension plate and received in a guided manner in an allocated number of guide rails which can be fastened to the table. On the extension plate of the table widening often a rip fence for the workpiece is fastened here with it being possible that a distance of the rip fence to the tool be adjusted by means of a length scale so that a very wide workpiece can be cut to a desired dimension. On the opposite side of the table widening often transverse and/or mitre fences are provided in the case of common wood working machines to which a workpiece can be abutted under a desired angle to a longitudinal direction and/or a cutting direction of the workpiece, and can be guided in this position during treatment so that a guided angle cut can be carried out here.

Thus, document US 2005/0172772 A1 shows a circular saw with a machine table on which via two extension arms a table widening is attached which is pivotably fastened on the rip fence. The rip fence can be put onto the extension arms here on both sides of the machine table. For this purpose the extension arms comprise pre-drilled holes so that the rip fence module can be removed and attached to any desired pre-drilled hole and subsequently braced with corresponding clamps on the extension arms. But that involves the problem that the rip fence module always has to be adjusted first.

The British patent application GB 2 317 851 A (D2) moreover shows a circular saw where the extension arms on which a rip fence is fastened can be attached to both sides of the machine table.

It is often advantageous when the rip fence can be moved and adjusted independent of the table widening. The US documents U.S. Pat. No. 6,986,370 B1 and U.S. Pat. No. 6,293,176 B1 show wood working machines with a table widening module fastened extensibly on the machine table via guide arms on the front and rear side with it being possible that a rip fence can be inserted in grooves into the guide arms.

Finally, the German utility model DE 29801127 U1 shows already a wood working machine with a worktable where identical table widening modules are provided on both sides. A rip fence module is attachable or fastenable here either on the machine table or on the extension plate of the table widening on the side facing towards the operator.

It is the objective of the present invention to permit for a wood working machine of the generic type a large field of application of the wood working machine with cost-effective setup and simple handling.

This objective is achieved with the features of claim 1.

According to the invention the extension element for retrofit from the side of the machine table extending in the extension direction to the opposite side of the machine table is formed with extension arms fastened to the extension plate in order to widen the machine table optionally on the one or on the other side. The guide rails allocated to the two extension arms are formed here in a condition fastened on the table for receiving and withdrawal of the two extension arms with an extension plate positioned optionally on the side of the machine table extending in extension direction or on the opposite side of the machine table, i.e. while the guide rail is fastened to the machine table or the machine tool. Usually, two guide rails are provided here, each one on the front and rear side of the machine table in which one of the extension arms each is guided between which in turn the extension plate is mounted flush on its upper surface to the upper surface of the machine table. The extension arms of the wood working machine and accordingly the allocated guide rails extend in parallel here and are formed in an axially symmetrical manner of equal dimension as profiles or sections with constant cross section over their length with the guide rails each comprising a guide groove in which the extension arms are guided with a sliding portion. The wood working machine is moreover characterised by the fact that a shiftably guided rip fence module is provided on and/or in the extension arms opposite the machine table and the extension plate.

Due to the identity of parts of the extension arms and guide rails resp., i.e. because each extension arm fits into each guide rail, a fast and simple retrofit of the table widening from one side to the other side of the machine tool is possible without it being necessary that the machine tool and/or the table widening module would have to be entirely disassembled and the guide rails would have to separated from the machine table and/or the machine tool. Independent of the extension position of the extension element on one or the other side of the table, the rip fence module is received shiftably on both identical extension arms. On retrofit of the extension element of the table widening module to the other side of the machine table, the rip fence module can be totally withdrawn from the extension element. After attachment of the extension element on the other side of the machine table, the rip fence module can then be reinstalled. Thus, the actuating elements of the rip fence module on the operator's side point to the operator also when the extension element is placed on the opposite machine table side.

For this purpose, the extension arms preferably comprise each an undercut rip fence shifting groove into which the rip fence module is received.

With retrofit of the table widening on the machine table side located opposite the usual extension direction, for example, a mitre fence module existing there can also be used for very wide workpieces without the risks of injury described above having to occur. Moreover, depending on the place of installation and the place conditions existing there, such a machine tool can be configured freely, which is of particular advantage in the case of machines used on building sites and especially, if retrofit occurs rapidly and easily.

For this, it is advantageous, if the two guide rails are fastened to the sides of the machine table extending in the extension direction, and at least mainly form the respective guide groove and are entirely penetrated by it.

Moreover, the guide grooves advantageously can comprise at least in sections a lining, and/or the sliding portions at least in sections a covering with the lining and/or covering at least on its glide surface consisting of a material with good gliding qualities with respect to the material of the profile or section components. Thus, bearing arrangement is particularly smooth-running so that the extension arms can simply be extracted from the guide rails and reinserted into them again.

In the case of generic table widening modules and/or wood working machines moreover a locking device to be fastened on the table is provided, by means of which the extension arms can be locked and released in the allocated guide rails with a desired distance of the extension plate to the machine table. In the case of the table widening module and/or the wood working machine according to the present invention it is especially advantageous here, if the locking device for locking the extension arms is suitable not only in the case of the extension plate being positioned on the machine table side extended in extension direction but also in the case of the extension plate being positioned on the machine table side opposite to the extension direction, without a retrofit having to be necessary.

This applies in particular, if in the case of the extension plate being positioned on the machine table side opposite the extension direction and spaced apart from the machine table, a locking is likewise possible via the locking device, without it being necessary that the locking device must be retrofitted, i.e. without that the fastening of the locking device fastenable on the table would have to be released and the locking device would have to be mounted again in another location of the machine table. Hence, reconfiguration of the machine tool is further facilitated in a considerable way.

For this purpose, the locking device can comprise advantageously a number of locking blocks movable in this position transversely to the extension direction between a locking position and a release position, with at least one of the number of extension arms comprising at least one bearing surface extending in parallel to the extension direction, against which the number of locking blocks is urged in the locking position, with the extension arm being guided such that the extension arm is held up against the pressed-on locking block.

The respective bearing surface in the extension direction is provided here preferably opposite the respective locking block without undercut on the extension arms so that the extension arm can be removed from the guide rail, when the locking block is in the release position. But the user must itself ensure here that the extension element is not extended beyond the locking block.

But it would also be imaginable to provide an undercut for the locking block on the bearing surface in order to provide a stop against excessive extension of the extension arm. Particularly suitable within the meaning of a simple retrofit of the extension element from one table side to the other would be here an undercut on a component, which can be easily disassembled, such as for example on a sliding cap placed onto the end of the extension arm received in the guide rail. Moreover, the locking device could also be designed such that the locking block(s) can be put into a withdrawal position and comprise a stroke between the release position and the withdrawal position required for overcoming the undercut.

Particularly advantageous is moreover a further embodiment of the invention where a latch element is provided on the end of the extension arm received in the respective guide rail which can be put into a locked position and in an unlocked position. In the locked position the latch element can form a stop projecting from the bearing surface for the allocated locking block or a counter-stop element fastened on the exterior of the allocated guide rail in order to prevent an excessive extension with the stop put into the unlocked position not undercutting the bearing surface and/or not hitting the counter-stop provided on the guide rail so that the extension arms can be extracted from the guide rails.

Advantageously, the latch element can be formed on the sliding cap placed onto the extension arm. The latch element can, for example, comprise a slide latch or a flap latch which is provided on a sliding cap screwed onto the respective extension arm. If the extension element is supposed to be removed, the flap latch can be turned down from its service position forming a stop for the locking block into a withdrawal position. Preferably, a safety device such as for example a pin exists here maintaining the flap latch in the service position.

Advantageously, at least on one of the extension arms an end cap is fixed on its end facing away from the table comprising a larger diameter than the extension arm or a projection protruding beyond the diameter of the extension arm. The end cap can then serve as a protection against an undesirable removal of the rip fence module from the extension arms.

Moreover, a pointer and/or a window can advantageously be provided on the rip fence module and a scale on the front guide rail allocated to the pointer and/or window. In the case of a rip fence module attached on the extension arms in the area of the machine table, the distance of the rip fence from the workpiece can then be read on the scale by means of the pointer and/or the window.

For reading the distance of the rip fence from the workpiece in the case of a rip fence module attached to the extension plate, moreover, at least on the front extension arm or on the sliding cap attached to it a pointer can be mounted and on the front guide rail a scale allocated to the pointer on the side of the extension arm.

If here on both ends of the front guide rail a scale is provided allocated to the pointer and/or window on the rip fence, the distance of the rip fence from the workpiece can be read by means of the pointer and/or window on either allocated scale, depending on whether the rip fence module is placed on the machine table on the side located in the extension direction or on the side opposite the extension direction. If, moreover, on the two sliding caps each one pointer is fitted, and on both ends of the front guide rail a scale is provided for one of the pointers on the side of the extension arm, depending on whether the table widening module and the rip fence module are placed on the machine table side located in the extension direction or on the machine table side opposite the extension direction, the distance of the rip fence from the workpiece can be read by means of either pointer with it not being necessary that the extension element be disassembled.

The features of further dependent claims relate to the precise embodiment of the functional inventive idea with structural features which will be explained in detail in connection with the explanation of preferred embodiments of the invention by means of the attached drawings. It is to be mentioned here that the features of the embodiments shall be included in the main claims of the invention not only in the combination precisely shown and explained but also in any other combination appearing to be reasonable.

The drawings show:

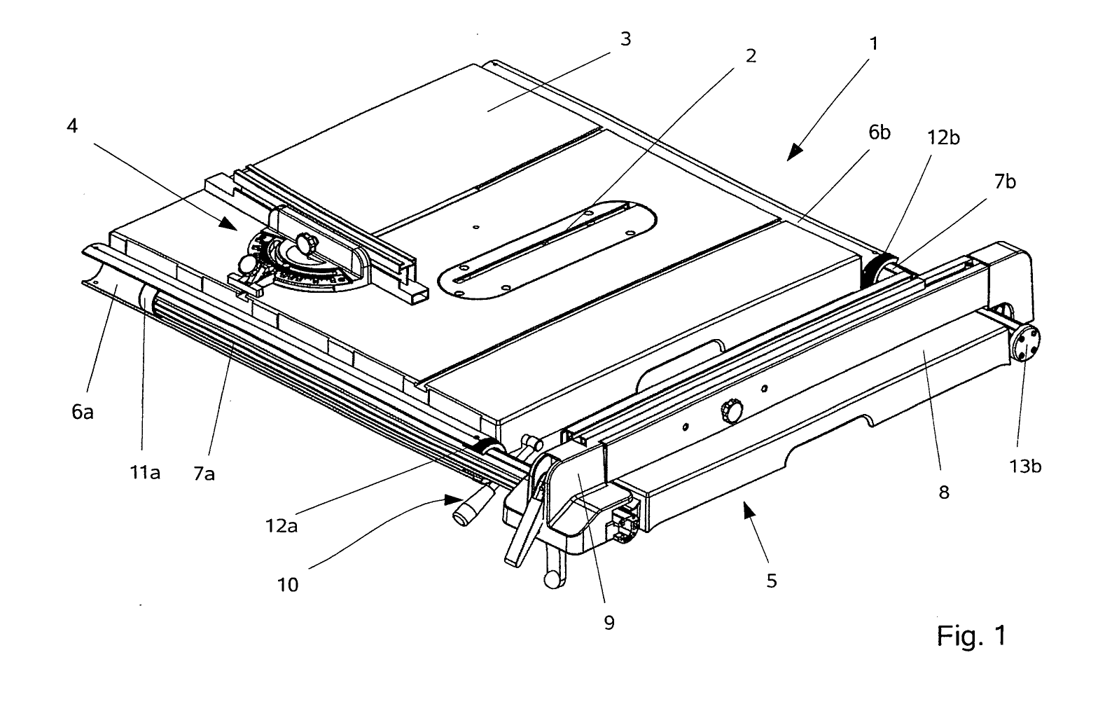

FIG. 1 a perspective view of a machine table of a circular saw with an attached table widening module according to a first embodiment of the invention;

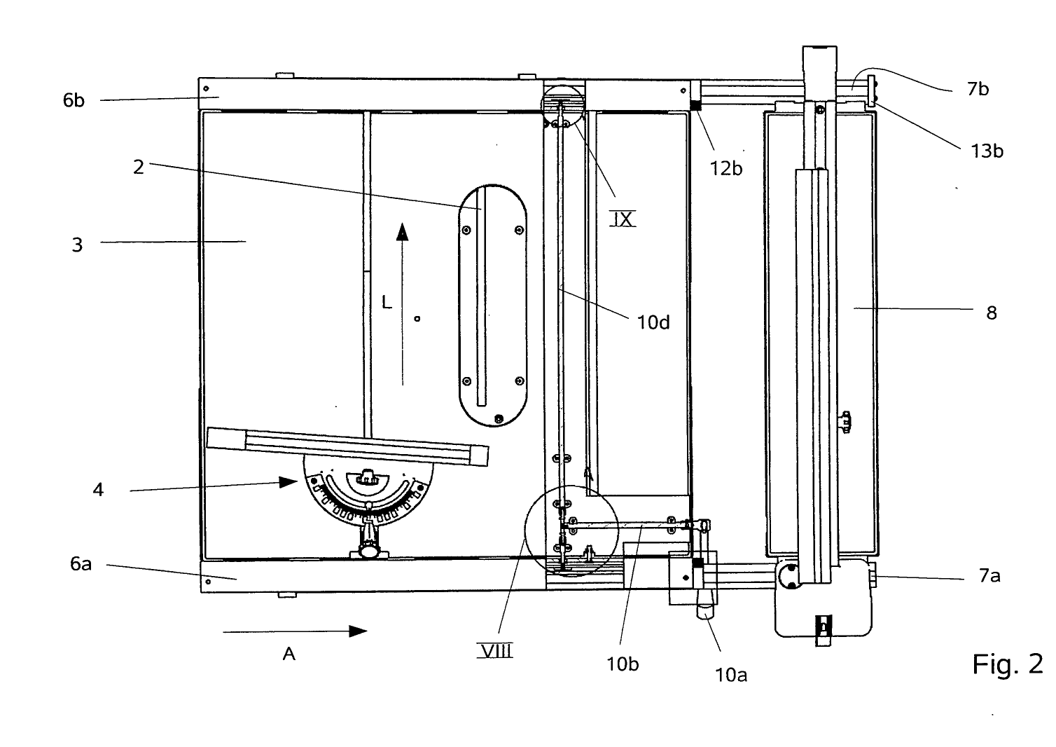

FIG. 2 a plan view of the circular saw shown in FIG. 1 with partly exploded view of the machine table;

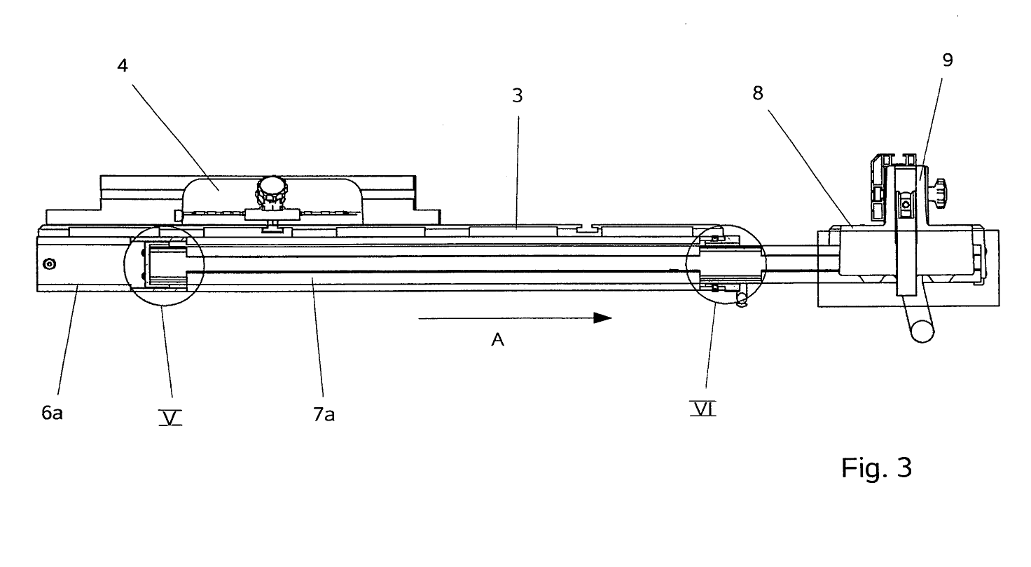

FIG. 3 a front view of the embodiment of the invention shown in FIGS. 1 and 2;

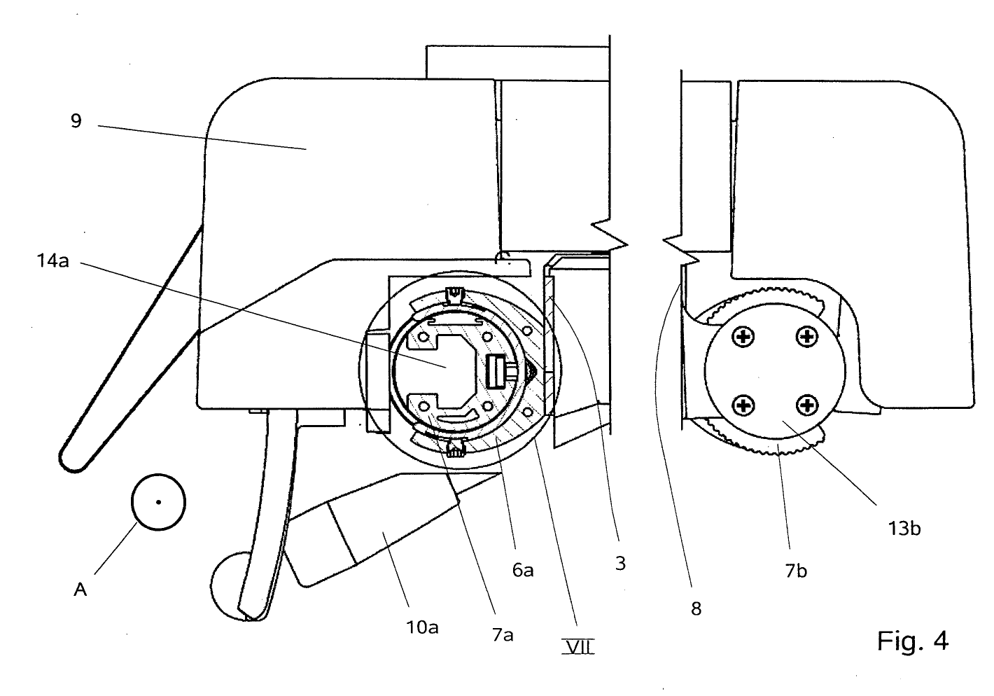

FIG. 4 an end face view with a partly exploded view of a guide rail on the operator's side and a guide arm received in it of the table widening module shown in the preceding figures;

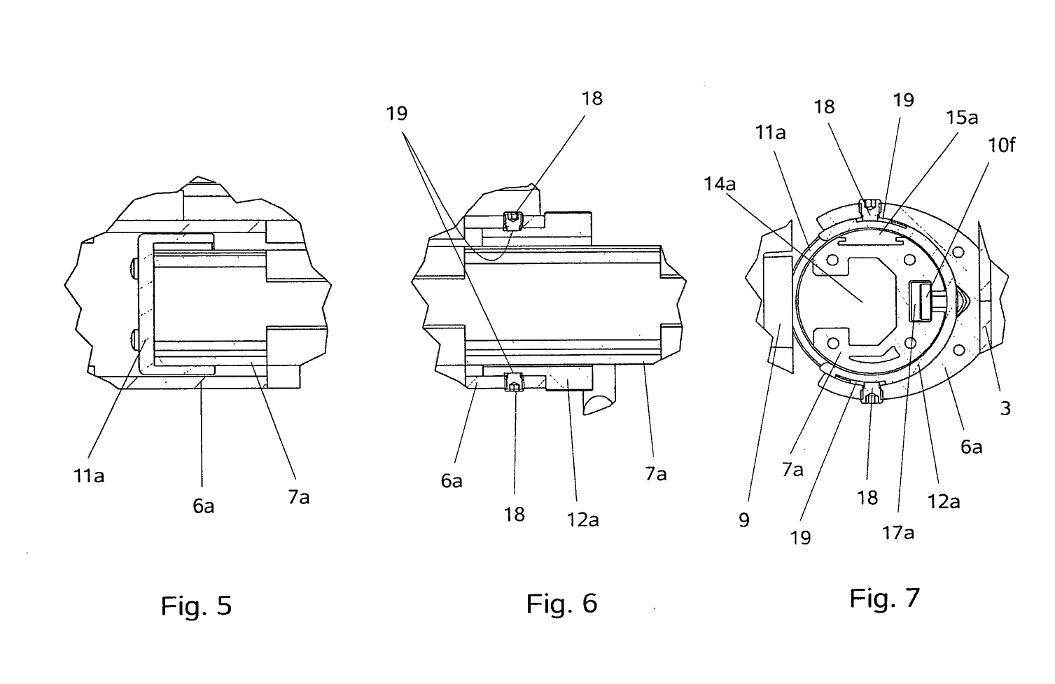

FIG. 5 detail V in FIG. 3;

FIG. 6 detail VI in FIG. 3;

FIG. 7 detail VII in FIG. 4;

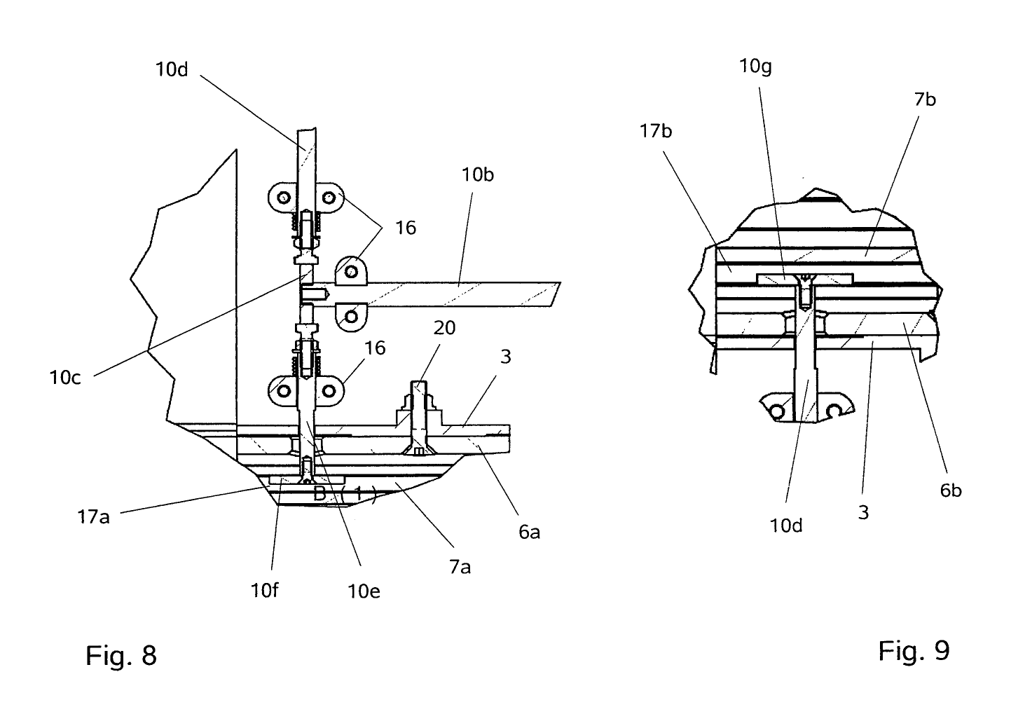

FIG. 8 detail VIII in FIG. 2; and

FIG. 9 detail IX in FIG. 2;

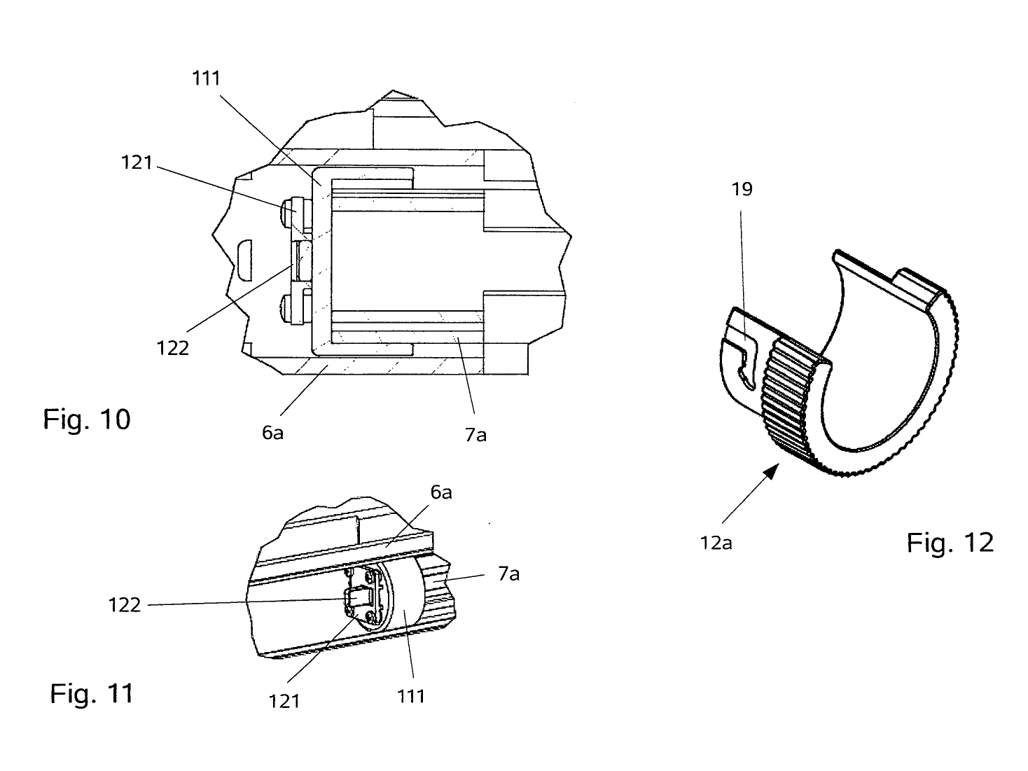

FIG. 10 a view corresponding to FIG. 5 of a sliding cap put onto an extension arm on another embodiment of the invention in a locked position;

FIG. 11 a perspective view of the sliding cap put onto the extension arm in the embodiment shown in FIG. 10 in a withdrawal position;

FIG. 12 a perspective view of a slide bush which is used in the embodiments of the invention shown in the preceding figures;

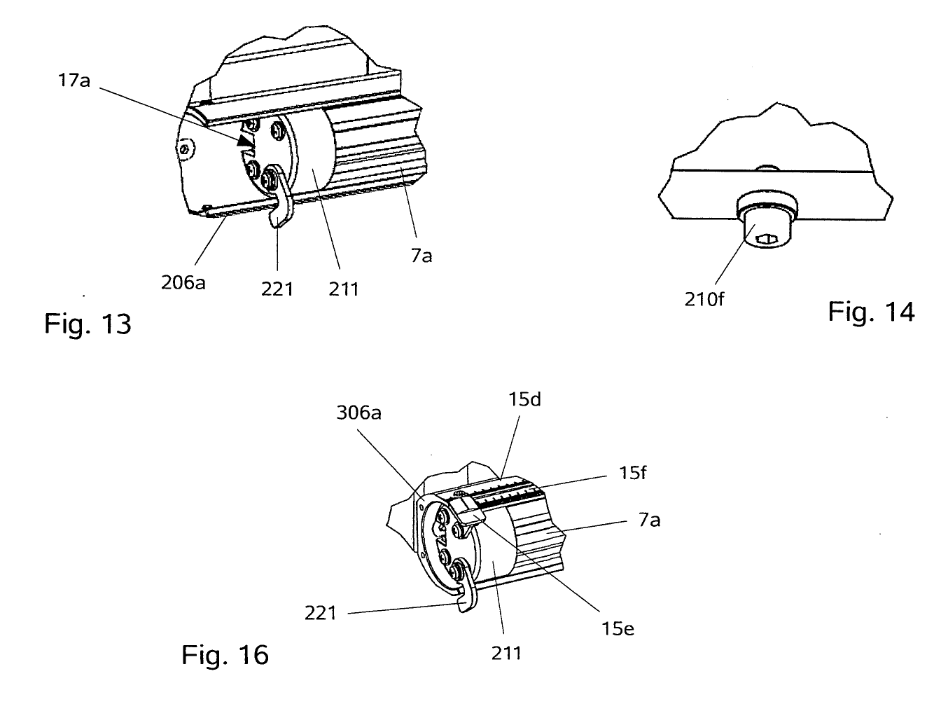

FIG. 13 a view corresponding to FIG. 11 of a sliding cap put onto an extension arm in another embodiment of the invention in a locked position;

FIG. 14 a detailed view of a stop screw provided on the external perimeter of a guide rail allocated to the sliding cap shown in FIG. 13;

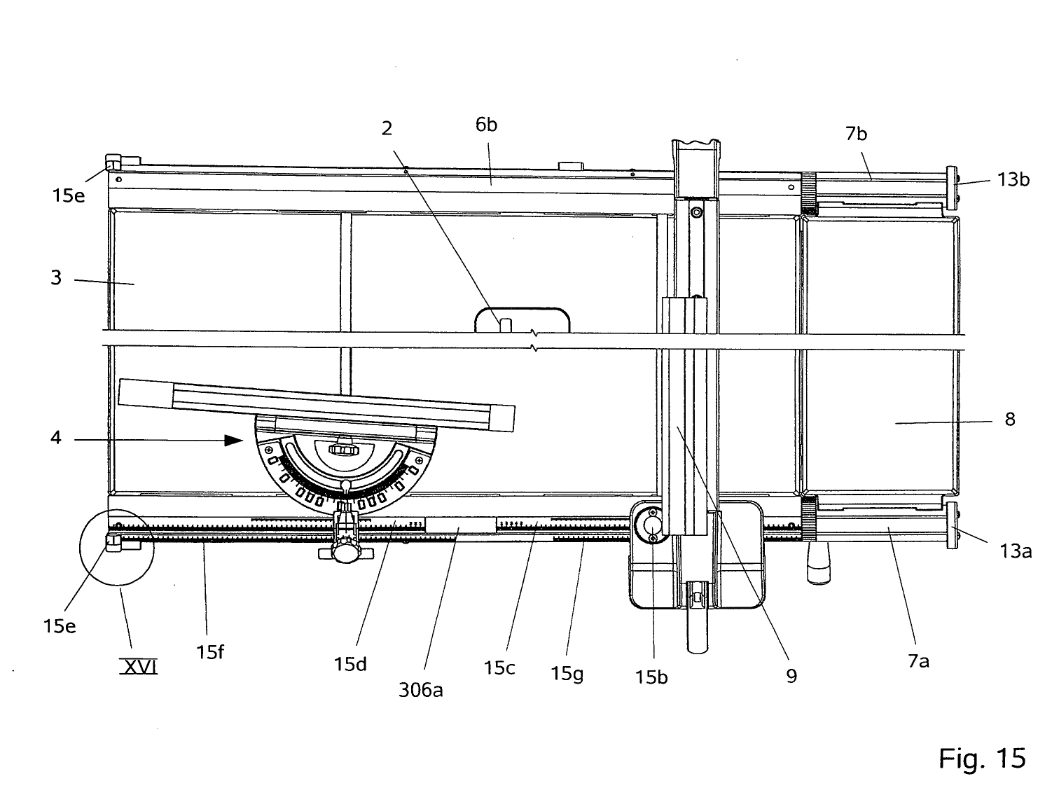

FIG. 15 a partly exploded plan view of a machine table of a circular saw with an attached table widening module according to a further embodiment of the embodiments of the invention shown in the preceding figures;

FIG. 16 a detailed view of the sliding cap put onto an extension arm shown in FIG. 13 with an additional pointer according to the further embodiment shown in FIG. 15.

At first, reference is made to the FIGS. 1 to 3, which show a machine table 3 of a circular saw designated with 1, to which a table widening module is laterally attached. The table widening module is located here on the side of the machine table 3 located in extension direction A (FIG. 2). A workpiece slot 2 is provided on the machine table 3 through which a circular saw blade (disk) can pass with on one side of the workpiece slot 2 an extension plate 8 of an extension element 5 of the table widening module being attached and on the other side of the workpiece slot 2 a mitre fence module. The table widening module is constructed such that the machine can be easily reconfigured by attaching the extension element 5 on the other side of the table.

For this purpose, alongside the machine table 2 a guide rail 6a, 6b each at the front and the rear is fitted into which two extension arms 7a, 7b are received in a guided manner among which the extension plate 8 is mounted with the upper side of the machine table 3 flush on top. Thus, the extension element 5 comprises apart from the extension plate 8 also the two extension arms 7a, 7b and need not be disassembled before being reinserted into the guide rails 6a, 6b on the other side of the table.

The guide rails 6a, 6b are penetrated over their entire length extending in the extension direction A by a guide groove 6a, 12a and/or 6b, 12b each, which is formed by the guide rail 6a, 6b itself and/or its internal cross section and a slide bush 12a, 12b each fitted on the part of the extension plate 8. The guide arms 7a, 7b are received in the respective guide groove 6a, 12a and 6b, 12b resp. in a guided manner, and have a constant cross-section, which is not undercut, over their entire length, which changes only by a sliding cap 11a—and/or 11b on the opposite side (not shown here)—put on and easily unscrewable on its end received in the respective guide groove 6a, 12a and 6b,12b resp.

The guide rails 6a, 6b and the extension arms 7a, 7b can be formed from extruded cast aluminium sections with other cast metals also being imaginable (e.g. cast magnesium for saving weight). The metal section of the extension arms 7a, 7b each slides off on the slide bushes 12a, 12b and the slide bushes 11a, 11b in the metal section of the guide rails 6a, 6b. The ends of the guide arms 7a each provided with one of the slide bushes 11a, 11b can be taken in detail from FIG. 5. One can see that the slide bushes 11a, 11b are screwed onto the ends of the respective extension arm 7a, 7b and slide off on the inner surface of the respective guide rail 6a, 6b in the respective guide groove 6a, 12a and 6b, 11b resp.

The sliding caps and the slide bushes can form a stop and a counter-stop here preventing an unintentional extraction of the guide arms out of the guide rails but permitting at the same time a fast and easy reconfiguration of the table widening module onto the other machine table side because this is achieved solely by a release and refitting of the sliding caps and/or slide bushes.

But for the embodiments shown of the invention advantageously a locking device 10 explained more in detail below is provided comprising locking blocks 10f, 10g (FIGS. 8, 9) received in grooves 17a, 17b which extend alongside the extension arms 7a, 7b, by means of which the extension element 5 can be fixed in a desired position. By this it is made sure that the extension arms 7a, 7b can also be locked in every service position because via the locking device 10 the locking blocks 10f, 10g in the locking groove 17a, 17b can be pressed against a bearing surface.

Stop and counter-stop against excessive extraction of the extension arms 7a, 7b are therefore formed in the embodiment of the invention shown in FIGS. 1 to 12 by the locking blocks 10f, 10g and the slide bush 11a, 11b (FIG. 5) and/or 111 (FIG. 10, 11), allocated in each case, on the end of the respective extension arm 7a, 7b received in the allocated guide rail 6a, 6b.

For reconfiguration of the machine with an extension element 5 located on the other table side, for embodiments with the sliding caps 11a and/or 11b shown in detail in FIG. 5, at least the sliding caps 11a, 11b must be removed here from the extension arms 7a, 7b, and retrofitted from the other table side after reinstallation of the extension arms 7a, 7b into the guide rails 6a, 6b. This is possible in a simple way by screwing (not referred to in detail) with the extension arms 7a, 7b. But it would also be imaginable here to provide the slide bushes with openings corresponding to the locking grooves 17a, 17b while it has to be ensured by other measures or manually by the operator that the extension arms 7a, 7b are not extracted out of the guide rails 6a, 6b beyond the lockable range.

An alternative embodiment of the invention having modified sliding caps 111, which need not be screwed off for retrofitting, but is otherwise unvaried compared to the embodiment shown in FIGS. 1 to 9, can be taken from FIGS. 10, 11. Here, for removal of the extension arms 7a, 7b from the guide rails 6a, 6b, on the sliding caps 111 a latch 122 provided on a latch support plate 121 must be extracted which latch forms the stop for the allocated locking block 10f, 10g. The sliding caps 111 can of course be provided on the front and rear extension arm 7a, 7b. But in theory it would be sufficient to provide a sliding cap 111 with the latch element and/or the latch support plate 121 only on one of the extension arms and on the other extension arm a sliding cap with a locking block guide groove without undercut. Thus, the sliding caps 111 together with the allocated extension arms 7a, 7b each form a sliding portion 7a, 111, 7b, 111.

Another alternative embodiment of the invention having further modified sliding caps 211 with a screwed-on external latch 221 projecting through a longitudinal front opening towards the outside of the allocated guide rail 206a, can moreover be taken from FIG. 13. Thus, this embodiment as well has modified sliding caps 211 compared with the embodiment shown in FIGS. 1 to 9, as well as a stop screw 210f shown in detail in FIG. 14 and screwed-in on the external perimeter of the guide rail 206a which in this embodiment instead of the locking block of the locking device forms a counter-stop for the external latch 221. For withdrawal of the extension arms 7a, 7b from the guide rails 206a, only the external latch 221 must be tilted upwards since, as is shown in FIG. 13, the sliding cap 211 comprises a recess corresponding to the locking groove 17a so that the locking groove 17a has no undercut. On the front and rear extension arm 207a one of the sliding caps 211 can of course be provided here. Then it would be sufficient, for example, to provide a stop 210f for the external latch 221 only on the front guide rail 206a, and on the rear side of the machine 1 a guide rail 6b unmodified compared to the preceding embodiments. Thus, the sliding caps 211 together with the allocated extension arms 7a, 7b each form a sliding portion 7a, 211, 7b, 211.

The ends of the guide rails 6a and 6b resp. facing towards the extension plate 8 and provided with the slide bushes 12a and 12b resp. are identical in construction in the embodiments shown and can be taken from FIG. 6. Moreover, FIG. 12 shows an individual view of the slide bush 12a which is identical in construction with slide bush 12b. Moreover, also the guide rails, extension arms and slide bushes on both sides of the machine table are preferably identical in construction as well. One can see that the slide bushes 12a, 12b are inserted into and/or fitted onto the guide rail 6a, 6b from the side. The respective guide rail 6a, 6b comprises threaded holes into which lock screws 18 are screwed and engage into a corresponding screw-in guide groove 19 on the slide bush 12a, 12b so that the slide bushes 12a, 12b are fixed on the guide rail 6a, 6b by means of the lock screws 18. The internal cross section of the guide rails 6a, 6b and the external cross section of the extension arms 7a, 7b is circular which has proven to be advantageous with respect to a rapid retrofit of the extension element 5 and a precise longitudinal guidance of the extension element 5.

If the extension element 5 is now supposed to be attached on the other side of the machine table 3, hence on the side of the mitre fence module 4, only the slide bushes 12a, 12b are each turned and disengaged with their screw-in guide grooves 19 on the lock screws 18. The extension arms 7a, 7b together with the extension plate 8 fitted on it can then be extracted from the guide rails 7a, 7b. Subsequently, the entire extension element 5 can be reinserted with its extension arms 7a, 7b into the two allocated guide rails 6a, 6b on the other side of the machine table 3. A device for releasable fixing of the slide bushes 12a, 12b is provided also on the other side here, namely—contrary to the graphic representation in which only two threaded holes are shown—also lock screws 18 so that the two slide bushes 12a, 12b can simply be fitted on there again and engaged by twisting.

But an embodiment of the slide bushes without screw-in guide grooves would also be imaginable where, however, the lock screws would have to released for withdrawal of the extension arms from the guide rails.

The slide bushes 12a, 12b and the sliding caps 11a, 11b and 111 and 211 resp. can be made here from different materials. But if they are made from a plastic material with good sliding qualities on the metal sections of the guide rails and/or the extension arms such as for example from a polyamide, additional lubrication in the two guide rails 6a, 6b can be omitted. In this connection it is irrelevant on which side of the guiding table 3 the extension element 5 is attached—hence on the side of machine table 3 located in the extension direction A (FIG. 2) or on the opposite side of the machine table 3. In both cases via the sliding cap 11a, 11b and/or 111 and/or 211 and the slide bushes 12a, 12b a secure bearing of the extension element 5 on the machine table 3 occurs with the locking device 10 being provided for fixation of the extension element in and/or contrary to the extension direction A in both cases which locking device is explained below in detail by reference to the FIGS. 2 and 4.

It has still to be pointed out here that a table widening module and/or a wood working machine with the features of the preamble of claims 1 and 28 resp. and the locking device according to the features of claim 12 and optionally according to the features described below and/or indicated in the claims 13 to 22 and described at the beginning could be made a subject of an own application.

The locking device 10 comprises a rotary handle 10a which is screwed on the underside of the machine table 3 via a spindle and/or shaft 10b and—as is particularly shown in FIG. 8—via band clamps 16 encompassing this spindle 10b. Via a rotary motion of the rotary handle 10a thus an eccentric disk 10c screwed onto the end of the spindle 10b opposite the rotary handle 11a can be twisted.

The eccentric disk 10c comprises a spiral segment shaped external surface on which on the one hand an end of a short expansion (clamping) shaft 10e extending towards the machine table front facing towards the operator abuts, and on the other hand an end of a long expansion (clamping) shaft 10d extending towards the machine table rear abuts. Alternatively the eccentric disk could also comprise corresponding guide grooves into which the expansion shaft ends are received in a guided manner.

The expansion shafts 10d, 10e again are screwed here on the machine table underside by means of band clamps 16. As can be taken from FIGS. 8 and 9, a locking block 10f, 10g each is screwed onto the ends of the two expansion shafts 10d, 10e facing away from each other which locking block is located in an allocated locking groove 17a and/or 17b in the respective extension arm 7a, 7b. The locking grooves 17a, 17b entirely penetrate the extension arms 7a, 7b in the extension direction A here so that the extension arms 7a, 7b can be extracted from the guide rail 6, 6b when the locking blocks 10f, 10g are in the release position. Expansion shaft means a shaft for operating a locking block.

In FIG. 4 and/or 7 the locking block 10f in the locking groove 17a is shown in a position abutting the bearing surface of the locking groove 17a, thus the locking position. The locking groove 17a and the locking groove 17b comprise undercut openings facing towards each other here extending in parallel to the extension direction A and being penetrated by the expansion shafts 10d, 10e. The bearing surfaces in the locking grooves 17a, 17b, however, are located on the inside and/or rear side of the undercuts.

As one can see best in FIG. 8, the two expansion shafts 10d, 10e are preloaded each via a bias spring fitted in the locking position—on one end on the eccentric disk 10c and on the other end on the respective expansion shaft 10d, 10e—hence in the position, in which the locking blocks 10f, 10g bear against the inner bearing surface in the respective locking groove 10a, 10b. The extension element 5—without actuation of the rotary handle 10a by the operator—is thus always in a condition locked in lateral direction and can only be put in the release position by an operator's intervention in order to change the distance of the extension plate 8 to the workpiece 2 or to retrofit the extension element 5 of the table widening module on the other side of the machine table 3.

If the extension element 5 is removed from the position shown in FIGS. 1 to 3 (in the position located in extension direction A adjacent to the machine table 3) and reinserted into the guide rails 6a, 6b on the other side of the machine table—as has been described above—a locking is achieved by the locking device 10 without the latter having to be retrofitted. Rather the locking device 10 can remain in place in the machine table 3, since both extension arms 7a, 7b are identical in dimension and construction, and due to their axially symmetrical arrangement can easily be slipped onto the locking block 10f with the locking groove 17b and/or onto the locking block 17g with the locking groove 17a after retrofit without resulting in a modification of the operating mode of the locking device 10.

In this connection it is particularly advantageous that the locking blocks 10f, 10g together with their expansion shafts 10d, 10e and the eccentric disk 10c are located in a central area of the machine table 3. Of course, by a “central area” an area adjacent to the workpiece slot 2 provided for the tool is meant here since on the tool itself there is no room for the locking device and/or its expansion shafts 10d, 10e because collisions would occur there with the tool drive and the tool itself.

In order to bridge the distance between the rotary handle 10a located on the machine table 3 side and the other parts of the drive line 10b, 10c, 10d, 10e of the locking device 10 located in the central area, a spindle 10b connecting the rotary handle 10a with the eccentric disk 10c is provided here. Thus it is made sure that not only in the extension direction A a large extension length can be achieved, which is finally limited by the fact that the extension arms 7a, 7b can still be grasped by the locking blocks 10f, 10g. If the extension arms 7a, 7b are secured here via the locking blocks 10f, 10g in the locking grooves 17a, 17b, this means that the locking blocks 10f, 10g still hit the flap latch 122 provided on the sliding caps 11a, 11b and/or on the sliding caps 111 at the undercut of the locking grooves 17a, 17b. For the embodiments where on the sliding caps 211 the external latch 221 projecting from the respective guide groove and as a stop for it the screw head of the stop screw fitted on the guide rail is provided, this means that the external latch 221 still strikes the screw head of the stop screw 210f.

Even in the case of an extension element 5 attached to the machine table 3 in opposite direction, a relatively large extension length can still be achieved, although it is limited due to the shorter distance of the locking blocks 10f, 10g from the sliding caps 11b, 11a (when the extension plate 8 abuts the machine table 3) and thus finally due to the arrangement of the locking blocks 10f, 10g offset slightly off-center to the extension direction A. But on this side the table top is broader up to the workpiece slot 2, hence up to the saw blade (disk) so that on both sides almost the same maximum extension length and/or supporting surface can be achieved.

Independent of the extension position of the extension element 5, the rip fence module 9 is received shiftably on the extension arms 7a, 7b. For this purpose, the extension arms 7a, 7b—as is best seen in FIGS. 4 and 7—each comprise another undercut rip fence shifting groove 14a in which the rip fence module 9 is received similar to the locking blocks 10f, 10g of the locking device 10 (not shown). Moreover, the two extension arms 7a, 7b each comprise another holding groove 15a on the upper side, into which a sheet metal plate with a plotted longitudinal scale can be received or glued in so that the operator can measure the distance of the rip fence from the workpiece on the workpiece slot 2. Moreover, an end cap 13b is screwed onto the end located on the side of the rip fence on the rear extension arm 7b serving as a retaining stop for the rip fence module 9. When retrofitting the extension element 5 of the table widening module onto the other machine table side, this end cap 13b can be removed, so that the rip fence module 9 can be removed in total from the extension element 8. After attachment of the extension element 5 on the other machine table side, the rip fence module 9 can then be attached again. Thus, the actuating means of the rip fence module 9 on the operator's side face towards the operator also when the extension element 5 is attached on the opposite machine table side 3. But removal of the end cap 13b is not mandatory, if the rip fence is configured such that it can be removed entirely from the table widening and reinserted on the other side without removal of the end cap 13b being necessary.

The guide rails 6a, 6b are fitted on the frame of the machine table and/or on the table top 3 here by means of guide rail fastening bolts 20 (FIG. 8) and according to the invention can remain in this fastened condition on the machine table 3, when the extension element 5 is supposed to be attached on the machine table 3 on the other machine table side.

In FIGS. 15 and 16 another embodiment of the invention is shown with scales 15c, 15d, 15f, 15g for the extension length of the rip fence 9 with the sliding cap 211 shown already in FIG. 13 being modified by the fact that here in addition to the external latch 221 a pointer 15e is screwed on it likewise projecting through the longitudinal front opening of an allocated front guide rail 306a. On the side opposite the extension direction A the scale 15f can then be attached on the guide rail 306a on which the extension length of the rip fence 9 attached on the machine table 3 side located in the extension direction A can be read by means of the pointer 15e.

As can be taken from FIG. 15, a sliding cap 211 with a pointer 15e attached to it can of course be provided on the front and rear extension arm 7a, 7b. If the table widening module is attached on the other table side so that the extension arm 7b is located in front on the machine table 3, thus a pointer 15e is available again in order to read the extension length of the rip fence module in the opposite direction on a second scale 15g attached on the other end of the front guide rail 306a.

Moreover, additional scales 15c, 15d can be provided on both ends of the front guide rail 306a on which the distance to the workpiece 2 can be read in each case by an allocated window 15b on the rip fence module 9, when the rip fence module 9 is attached to the machine table 3. If the operator, however, wishes to attach the rip fence module 9 on the extension plate 8 of the table widening, at first the rip fence 9 must be moved against the end caps 13a, 13b. The measure can then be read by means of the pointer 15e on another scale attached to the guide rail 306a which pointer is fitted on the end of the extension arm 306a located in the guide rail 7a and/or on the sliding cap 211. In both cases it can be seen how far a workpiece stop of the rip fence is away from the tool and/or the workpiece slot 2.

It has still to be pointed out here that a table widening module and/or a wood working machine with the features of the preamble of claims 1 and 28 resp. with a rip fence module and a distance reading means according to the features of claims 22, 23 and 24 and optionally according to the features indicated in the claims 25 to 27 and described at the beginning as well as the features described above in connection with the embodiment shown in FIGS. 15 and 16 could be made a subject of an own application.

Variations and modification of the embodiment shown are self-evidently possible without abandoning the scope the invention.

Thus, it would be imaginable, for example, to provide the open ends of the guide rails on the equipment with a covering cap for releasable fitting of the slide bushes. It would also be imaginable to provide both ends of the guide rails with slide bushes and to remove only the slide bushes from the guide arms when retrofitting the extension element from one machine table side to the other so that these can be extracted from the guide rails and be reinserted on the opposite side.

Moreover, it would be imaginable—instead of providing one locking block for each extension arm and positioning the two locking blocks in a central area of the machine table in order to achieve a sufficient extension length also on the machine table side opposite the extension direction—to provide, not only in a lateral area of the machine table located in the extension direction but also in a lateral area of the machine table located opposite the extension direction, either locking blocks for each guide arm, or a locking block for one guide arm on one table end and a locking block for the other guide arm on the other table end. Accordingly, two eccentric disks spaced apart from each other in extension direction would be necessary in that case which could be received on a common spindle and be actuated by means of the rotary lever.

The pointer 15e could of course be provided for all sliding caps described above as well as alternatively or in addition to the external latch 211 and/or the latch element 121.

Thus the invention is embodied in the features of the co-ordinated claims which in accordance with advantageous embodiments can be combined in any way with the features of the dependent claims and the features of the following items in so far as this seems to be reasonable:
1. A table widening module according to claim 13 or 14, characterised in that in a lateral area of the machine table located in extension direction and in a lateral area of the machine table located opposite the extension direction a locking block each is provided for at least one of the extension arms.
2. A table widening module according to claim 13 or 14, characterised in that in a central area of the machine table (3) adjacent to the tool (2) each one locking block (10f, 10g) is provided for at least one of the extension arms (7a, 7b).
3. A table widening module according to any one of claims 13 to 16, characterised in that the locking device (10) for movement of the number of locking blocks (10f, 10g) comprises a rotary handle (10a) fastenable on the table and rotatable in this condition around an axis of rotation parallel to the extension direction (A), which is situated on the side located in the extension direction (A) or the opposite side adjacent to the machine table (3), and a drive line (10b, 10c, 10d, 10e) by means of which a rotation of the rotary handle (10a) is converted into a movement of the number of locking blocks (10f, 10g) between the locking position and release position.
4. A table widening module according to claim 17, characterised in that the drive line (10b, 10c, 10d, 10e) comprises at least an eccentric disk (10c) connected with the rotary handle (10a) in a torque transmitting manner by means of which the expansion shafts (10d, 10e) are shiftable with the locking blocks (10f, 10g) fitted on them between the locking position and the release position, are fastenable on the table and on their external ends facing away from each other and carry one of the locking blocks (10f, 10g) each and abut the eccentric perimeter surface of the allocated eccentric disk (10c) on their internal ends facing each other in pairs.
5. A table widening module according to claim 18, characterised in that the eccentric disk (10c) for each of the allocated expansion shafts (10d, 10e) comprises an eccentrically extending eccentric groove in which the expansion shaft (10d, 10e) is guided with its end facing away from the allocated locking block (10f, 10g), with a bias spring each preloading the expansion shaft (10d, 10e) in the locking position being advantageously connected with the eccentric disk (10c).
6. A table widening module according to claim 18 or 19, characterised in that the expansion shafts (10d, 10e) are fastenable underneath on the machine table (3) and the expansion shaft (10d) extending towards a side of the machine table (3) facing away from an operator is so much longer than the expansion shaft (10e) extending towards the operator's side that the axis of rotation of the rotary handle (10a) in the area covered by the machine table (3) is adjacent to the side of the machine table (3) facing towards the operator.
7. A table widening module according to claim 18, 19 or 20, characterised in that the rotary handle (10a) via a spindle (10b) fastenable on the underside of the machine table (3) is connected with the single eccentric disk (10c) located in a central area of the machine table (3) adjacent the tool (2) underneath the machine table (3), via which eccentric disk (10c) two expansion shafts (10d, 10e) each extending towards one of the extension arms are movable.
8. A table widening module according to claim 22, characterised in that a pointer and/or window (15b) is provided on the rip fence module (9) and on the front guide rail (306a) a scale allocated to the pointer (15c) and/or window on the side of the rip fence.
9. A table widening module according to claim 22 or 23, characterised in that at least on the front extension arm (7a, 7b) or the sliding cap (211) fastened on it a pointer (15e) is located, and on the front guide rail (306a) a scale (15f) allocated to the pointer (15e) on the side of the extension arm.
10. A table widening module according to claim 23 or 24, characterised in that on both ends of the front guide rail (306a) a scale (15c, 15d) allocated to the pointer and/or window on the rip fence side is provided.
11. A table widening module according to claim 24 or 25, characterised in that on the two sliding caps (211) one pointer (15e) each is located and an allocated scale (15f, 15g) on both ends of the front guide rail (306a).
12. A table widening module according to any one of the preceding claims, characterised in that on at least one of the extension arms (7a, 7b) on its end facing away from the table an end cap (13a, 13b) fixed releasably is attached comprising a larger diameter than the extension arm (7a, 7b) or a projection protruding the diameter of the extension arm (7a, 7b).

### LIST OF REFERENCE NUMERALS

A extension direction

L longitudinal direction

1 circular saw (machine tool)

2 tool slot

3 machine table

4 mitre fence module

5 extension element

6a, 12a, 6b, 12b guide grooves (guided portion)

6a front guide rail

6b rear guide rail

7a, 11a, 7b, 11b sliding portion

7a front extension arm

7b rear extension arm

8 extension plate

9 rip fence module

10 locking device

10b, 10c, 10d, 10e, drive line of the locking device

10a rotary lever

10b spindle

10c eccentric disk

10d long expansion (clamping) shaft

10e short expansion (clamping)shaft

10f, 10g locking blocks

11a, 11b sliding caps (covering)

12a, 12b slide bushes (lining)

13a front end cap

13b rear end cap

14a rip fence shifting groove

15a holding groove for width scale

16 fastening band clamps

17a front locking groove

17b rear locking groove

18 slide bush lock screw

19 screw-in guide grooves

20 guide rail fastening bolt

7a, 111, 7b, 111 sliding portion

111 sliding cap

121 latch support plate (latch element)

122 flat latch

7a, 211, 7b, 211 sliding portion

211 sliding cap

206a, 12a, 206b, 12b guide grooves (guided portion)

206a front guide rails with stop screw

206b rear guide rails with stop screw

210f stop screw

221 external latch

306a, 12a, 206b, 12b guide grooves (guided portion)

306a front guide rail with scales and stop screw

15b window

15c window scale for rip fence attached in extension direction on the machine table

15d window scale for rip fence attached opposite the extension direction on the machine table

15e pointer

15f scale with pointer for rip fence attached on the extension element in the extension direction

15g scale with pointer for rip fence attached on the extension element opposite the extension direction

1. A wood working machine (1), in particular a circular saw (1), comprising a machine table (3) on which two guide rails (6a, 6b; 206a, 6b; 306a, 6b) are fastened and which is penetrated by a working tool (2), and an extension element (5) which for widening of the machine table (3) presents an extension plate (8) in particular flush on top with the machine table (3) and which can be positioned adjacent to the machine table (3) in an extension direction (A), as well as two extension arms (7a, 7b) fixed to the extension plate (8) and received in a guided manner in the guide rails (6a, 6b; 206a, 6b; 306a, 6b) in the extension direction (A) so that the distance of the extension plate (8) to the machine table (3) is modifiable with
each guide rail (6a, 6b; 206a, 6b; 306a, 6b) being penetrated by a guide groove (6a, 12a, 6b, 12b; 206a, 12a, 206a, 6b; 306a, 12a, 6b, 12b), and a sliding portion (7a, 11a, 7b, 11b; 7a, 111, 7b, 111; 7a, 211, 7b, 211) being provided on each extension arm (7a, 7b) which sliding portion comprises an external cross section corresponding to the internal cross section of the guide groove (6a, 12a, 6b, 12b; 206a, 12a, 206a, 6b; 306a, 12a, 6b, 12b) so that each extension arm (7a, 7b) with its sliding portion (7a, 11a, 7b, 11b; 7a, 111, 7b, 111; 7a, 211, 7b, 211) is guided slidingly in the allocated guide groove (6a, 12a, 6b, 12b; 206a, 12a, 206a, 6b;306a, 12a, 6b, 12b),
characterised in that
the extension element (5) is formed for retrofit from the machine table (3) side located in the extension direction (A) to the opposite machine table (3) side with extension arms (7a, 7b) fitted to the extension plate (8) in order to widen the machine table (3) optionally on the one or on the other side and that the two guide rails (6a, 6b; 206a, 6b; 306a, 6b) are formed for receiving and removing the allocated extension arms (7a, 7b) are formed in a condition of the said guide rails fastened to the table with the extension plate (8) positioned optionally on the machine table (3) side located in the extension direction (A) or with the extension plate (8) positioned on the machine table (3) side located in the opposite direction, with
the extension arms (7a, 7b) being located in an axially symmetrical manner, of equal dimension and formed as profiles or sections with constant cross section, and the wood working machine comprising a rip fence module (9) guided shiftably on and/or in the extension arms (7a, 7b).

2. A wood working machine (1) according to claim 1, characterised in that the extension arms (7a, 7b) each comprise an undercut rip fence shifting groove (14a) and that the rip fence module (9) is received in the rip fence shifting grooves (14a).

3. A wood working machine (1) according to claim 1, characterised in that the internal cross section of the guide rails (6a, 6b; 206a, 6b; 306a, 6b) on their longitudinal side facing away from the table in the fastened condition is open and undercut.

4. A wood working machine (1) according to claim 1, characterised in that on at least one of the extension arms (7a, 7b) an end cap (13b) is fixed on its end facing away from the table which has a larger diameter than the extension arm (7a, 7b) or that a projection protruding from the diameter of the extension arm is provided.

5. A wood working machine (1) according to claim 1, characterised in that two guide rails (6a, 6b; 206a, 6b; 306a, 6b) of equal dimension, running in parallel and fastenable in an axially symmetrical manner on the sides running in the extension direction (A) of the machine table (3) or of the machine (1) are provided which guide rails comprise an internal cross section constant over their length which forms the respective guide groove (6a, 12a, 6b, 12b; 206a, 12a, 206a, 6b; 306a, 12a, 6b, 12b) at least predominantly.

6. A wood working machine (1) according to claim 1, characterised in that the guide rails (6a, 6b; 206a, 6b; 306a, 6b) and the extension arms (7a, 7b) each are formed from a preferably extruded section component, for example from metal, at least one, preferably both guide grooves (6a, 12a, 6b, 12b; 206a, 12a, 206a, 6b; 306a, 12a, 6b, 12b) at least in sections comprise a lining (12a, 12b), for example out of plastic material, and/or at least one, preferably both sliding portions (7a, 11a, 7b, 11b; 7a, 111, 7b, 111; 7a, 211, 7b, 211) at least in sections comprise a covering (11a, 11b; 111; 211), for example out of a plastic material, with the lining (12a, 12b) and/or covering (11a, 11b; 111; 211) at least on its glide surface consisting of a material with good gliding qualities with respect to the material of the section components.

7. A wood working machine (1) according to claim 6, characterised in that each plastic covering (11a, 11b; 111; 211) is formed each as a sliding cap (11a, 11b; 111; 211) placed onto the end of the respective extension arm (7a, 7b) received in the allocated guide groove (6a, 12a, 6b, 12b; 206a, 12a, 206a, 6b; 306a, 12a, 6b, 12b) on which sliding cap the extension arm (7a, 7b) slides off in the guide groove (6a, 12a, 6b, 12b; 206a, 12a, 206a, 6b; 306a, 12a, 6b, 12b), preferably in the metal profile or section of the guide rail (6a, 6b; 206a, 6b; 306a, 6b).

8. A wood working machine (1) according to claim 6, characterised in that each lining (12a, 12b) is formed as at least one slide bush 12a, 12b placed onto at least one of the two ends of the allocated guide rail (6a, 6b; 206a, 6b; 306a, 6b), with the allocated extension arm (7a, 7b) sliding off on the slide bush 12a, 12b preferably with its metal profile or section, which is located on the side of the extension plate (8).

9. A wood working machine (1) according to claim 8, characterised in that on both opposite ends of the guide rails a device is provided for releasable fixing of one slide bush (12a, 12b) each so that the slide bush (12a, 12b)—depending on whether the extension plate (8) is supposed to be positioned on the machine table (3) side located in the extension direction (A) or on the machine table (3) side located in the opposite direction—can be placed onto the guide rail end located in the extension direction (A) or on the guide rail end located in the opposite direction.

10. A wood working machine (1) according to claim 8, characterised in that a slide bush-is provided on both opposite guide rail ends.

11. A wood working machine (1) according to claim 1, characterised in that the internal cross section of the guide rails (6a, 6b; 206a, 6b; 306a, 6b) and the external cross section of the extension arms (7a, 7b) is substantially circular.

12. A wood working machine (1) according to claim 1, characterised in that a locking device (10) fastenable on the table is provided by means of which the number of extension arms (7a, 7b) can be locked and released in the number of guide rails (6a, 6b; 206a, 6b; 306a, 6b) with a desired distance of the extension plate (8) to the machine table (3), with the locking device (10) being suitable for locking of the extension arms (7a, 7b) not only when the extension plate (8) is positioned on the machine table (3) side located in the extension direction (A) but also when the extension plate (8) is positioned on the machine table (3) located in the opposite direction, especially when the extension plate (8) is positioned on the machine table (3) side located in the opposite direction and spaced apart from the machine table (3), without having to be retrofitted.

13. A wood working machine (1) according to claim 12, characterised in that the locking device (10) comprises a number of locking blocks (10f, 10g) fastenable on the table and movable in this position transversely to the extension direction (A) between a locking position and a release position, with at least one of the number of extension arms (7a, 7b) comprising at least one bearing surface extending in parallel to the extension direction (A) against which the number of locking blocks (10f, 10g) is pressed in the locking position, with the extension arm (7a, 7b) being guided such that the extension arm (7a, 7b) is held up against the pressed-on locking block (10f, 10g).

14. A wood working machine (1) according to claim 13, characterised in that both extension arms (7a, 7b) each comprise a locking groove (17a, 17b), with the locking grooves (17a, 17b) on the sides of the extension arms facing each other comprising an undercut opening and bearing surfaces facing away from each other on the rear side of the undercut, and at least one locking block (10f, 10g) being provided for each of the extension arms (7a, 7b) which locking block is operable via a clamping shaft (10d, 10e) fastened to the locking block (10f, 10g) and passing through the undercut.

15. A wood working machine (1) according to claim 2, characterised in that the internal cross section of the guide rails (6a, 6b; 206a, 6b; 306a, 6b) on their longitudinal side facing away from the table in the fastened condition is open and undercut.

16. A wood working machine (1) according to claim 2, characterised in that on at least one of the extension arms (7a, 7b) an end cap (13b) is fixed on its end facing away from the table which has a larger diameter than the extension arm (7a, 7b) or that a projection protruding from the diameter of the extension arm is provided.

17. A wood working machine (1) according to claim 3, characterised in that on at least one of the extension arms (7a, 7b) an end cap (13b) is fixed on its end facing away from the table which has a larger diameter than the extension arm (7a, 7b) or that a projection protruding from the diameter of the extension arm is provided.

18. A wood working machine (1) according to claim 2, characterised in that two guide rails (6a, 6b; 206a, 6b; 306a, 6b) of equal dimension, running in parallel and fastenable in an axially symmetrical manner on the sides running in the extension direction (A) of the machine table (3) or of the machine (1) are provided which guide rails comprise an internal cross section constant over their length which forms the respective guide groove (6a, 12a, 6b, 12b; 206a, 12a, 206a, 6b; 306a, 12a, 6b, 12b) at least predominantly.

19. A wood working machine (1) according to claim 3, characterised in that two guide rails (6a, 6b; 206a, 6b; 306a, 6b) of equal dimension, running in parallel and fastenable in an axially symmetrical manner on the sides running in the extension direction (A) of the machine table (3) or of the machine (1) are provided which guide rails comprise an internal cross section constant over their length which forms the respective guide groove (6a, 12a, 6b, 12b; 206a, 12a, 206a, 6b; 306a, 12a, 6b, 12b) at least predominantly.

20. A wood working machine (1) according to claim 5, characterised in that two guide rails (6a, 6b; 206a, 6b; 306a, 6b) of equal dimension, running in parallel and fastenable in an axially symmetrical manner on the sides running in the extension direction (A) of the machine table (3) or of the machine (1) are provided which guide rails comprise an internal cross section constant over their length which forms the respective guide groove (6a, 12a, 6b, 12b; 206a, 12a, 206a, 6b; 306a, 12a, 6b, 12b) at least predominantly.
